(19) United States
(12) Patent Application Publication
(10) Pub. No.: US 2010/0121024 A1
(43) Pub. Date: May 13, 2010

(54) METHOD FOR PRODUCING A COPOLYMER OF AT LEAST ONE CYCLIC MONOMER

(75) Inventors: Stèphanie Magnet, Morlanne (FR); Christophe Navarro, Lahonce (FR); Stèphanie Gazeau-Bureau, Frouzins (FR); Blanca Martin-Vaca, Toulouse (FR); Didier Bourissou, Plaisance Du Touch (FR)

Correspondence Address: RatnerPrestia, P.O. Box 980, Valley Forge, PA, 19482, US

(73) Assignees: Arkema France, Colombes (FR); Centre National De La Recherche Scientifique - CNRS, Paris, Cedex 16 (FR)

(21) Appl. No.: 12/527,105

(22) PCT Filed: Feb. 15, 2008
(86) PCT No.: PCT/FR2008/050256

§ 371 Date: Aug. 13, 2009

(30) Foreign Application Priority Data
Feb. 16, 2007 (FR) 07 01149

(51) Int. Cl. C08G 63/08

(52) U.S. Cl. 528/354

(57) ABSTRACT

The present invention relates to a process for the preparation of a copolymer of at least one cyclic monomer chosen from a lactone, a lactam, a lactide and a glycolide, comprising the stage consisting in reacting said cyclic monomer with a polymeric initiator in the presence of a compound carrying a sulfonic acid functional group.

It also relates to the polymer composition obtained according to this process and to its uses, in particular as antistatic additive.

The present invention relates to a process for the preparation of copolymers of at least one cyclic monomer chosen from lactones, lactams, lactides or glycolides by ring opening using a macroinitiator carrying a hydroxyl or thiol functional group.

Copolymers of lactones, such as ε-caprolactone, are polymers which are of a certain interest industrially in various fields, due in particular to their biocompatibility, their physicochemical properties and their good thermal stability up to temperatures of at least 200-250° C.

A process for the preparation of these copolymers has in particular been described by Jerome et al. in Macromol., 2002, 35, 1190-1195. It consists in copolymerizing δ-valerolactone with a macroinitiator, which is poly(ethylene glycol) or monomethoxypoly(ethylene glycol), in the presence of ethereal hydrochloric acid (HCl•Et₂O) in dichloromethane at 0° C. This process uses a monomer concentration of 3 mol.l⁻¹ and three equivalents of acid with respect to the hydroxyl functional groups of the macroinitiator, and the diblock and triblock polymers obtained after 2-3 h exhibit maximum weights Mₙ of 9500 to 19 000 g/mol, with a polydispersity index of 1.07 to 1.09.

This process requires the use of a relatively high amount of acid, which is furthermore corrosive, which can detrimentally affect the equipment used.

Other processes for the cationic copolymerization of ε-caprolactone have been provided which involve a sulfonic acid as catalyst instead of the hydrochloric acid.

Such a process has in particular been described by Maigorzata Basko et al. in Journal of Polymer Science: Part A: Polymer Chemistry, Vol. 44, 7071-7081 (2006). It consists in reacting s-caprolactone and optionally the L,L-lactide in the presence of isopropyl alcohol and trifluoromethanesulfonic (triflic) acid in dichloromethane at 35° C. Caprolactone copolymers having a molecular weight Mₙ ranging from 4780 to 5900 g/mol and a polydispersity index of 1.21 to 1.24 can thus be obtained.

Furthermore, application WO 2004/067602 discloses a process for the (co)polymerization of lactides and glycolides employing a trifluoromethane sulfonate as catalyst in the presence of a (co)polymerization additive or coinitiator, which can be water or an aliphatic alcohol, in an optionally chlorinated solvent.

However, it is not suggested that a process of the types described above can be used to prepare, under generally mild conditions and with rapid reaction kinetics, copolymers of lactones, lactams, lactides or glycolides with macromonomers themselves used as initiators, it being possible for the copolymers obtained to exhibit a high molecular weight Mₙ (optionally of greater than 20 000 g/mol) and a low polydispersity index (less than or equal to 1.5).

A subject matter of the present invention is thus a process for the preparation of a copolymer of at least one cyclic monomer chosen from a lactone, a lactam, a lactide and a glycolide, comprising the stage consisting in reacting said cyclic monomer with a polymeric initiator in the presence of a compound carrying a sulfonic acid functional group.

Another subject matter of the invention is a polymer composition capable of being obtained according to the above process and which will now be described in more detail.

The process according to the invention can be described as organocatalytic.

As a preliminary, it is specified that the expression “between” used in the context of this description should be understood as including the limits mentioned.

The process according to the invention comprises the reaction of a lactone, a lactam, a lactide or a glycolide with a polymeric initiator, hereinafter denoted more simply by “initiator”. “Initiator” is understood to mean, in the present description, a compound comprising at least one hydroxyl functional group or at least one thiol functional group. “Polymeric” refers to a molecule, the structure of which essentially comprises the multiple repetition of units derived, effectively (by any type of polymerization reaction) or conceptually, from molecules with a lower molecular weight. This term encompasses both polymers (macromolecules) and oligomers, the latter having a lower molecular weight than the former.

“Copolymer” is understood to mean in particular a polymer derived from at least two different types of monomers or macromonomers, one at least of which is chosen from a lactone, a lactam, a lactide or a glycolide (hereinafter denoted more simply by “cyclic monomer”) another of which results from the polymeric initiator.

Examples of lactones comprise more particularly saturated or unsaturated and substituted or unsubstituted β-, γ-, δ- and ε-lactones comprising from 4 to 12 carbon atoms, such as ε-caprolactone, δ-valerolactone, β-butyrolactone and γ-butyrolactone. ε-Caprolactone is preferred for use in the present invention. It can in particular be obtained by Baeyer-Villiger oxidation of cyclohexanone with peracetic acid.

Examples of lactams comprise more particularly saturated or unsaturated and substituted or unsubstituted β-, γ-, δ- and ε-lactams including from 4 to 12 carbon atoms, such as caprolactam, pyrrolidinone, piperidone, enantholactam and laurinlactam. Caprolactam is preferred for use in the present invention. It can be obtained from cyclohexane oxime, by Beckmann arrangement, and results, by polymerization, in polycaprolactam or Nylon-6®.

The lactides used in the present invention can be provided in a racemic, enantiomerically pure or meso form.

The concentration of the cyclic monomer in the reaction medium can vary to some extent. It has thus been demonstrated that, for a degree of polymerization of approximately 40, a high concentration of monomer makes possible better control of the initiation of the polymerization by the initiator and thus better control of the polymerization. On the other hand, in the case of higher degrees of polymerization (in particular of greater than 100), a medium which is more dilute in monomer may become more favorable to better control. By way of example, the concentration of cyclic monomer in the reaction medium can vary from 0.01 to 9 and preferably from 0.45 to 3 mol/l, indeed even from 0.45 to 2.7 mol/l.

The initiator can be a mono- or polyhydroxylated oligomer or polymer, in particular chosen from: such as (methoxy) polyethylene glycol (MPEG/PEG), polypropylene glycol (PPG) and polytetramethylene glycol (PTMG); poly(alkyl)alkylene adipate diols, such as poly(2-methyl-1,3-propylene adipate) diol (PMPA) and poly(1,4-butylene adipate) diol (PBA); α-hydroxylated or α,ω-dihydroxylated polydienes which are optionally hydrogenated, such as α,γ-dihydroxylated polybutadiene or α,ω-dihydroxylated polyisoprene; mono- or polyhydroxylated polyalkylenes, such as mono- or polyhydroxylated polyisobutylene; polylactides comprising end hydroxyl functional groups;

polyhydroxyalkanoates, such as poly(3-hydroxybutyrate) and poly(3-hydroxyvalerate); modified or unmodified polysaccharides, such as starch, chitin, chitosan, dextran and cellulose; and their blends.

In an alternative form, the initiator can be an oligomer or polymer carrying one or more thiol functional groups, such as α-thiolated or α,ω-thiolated polystyrenes, α-thiolated or α,ω-thiolated poly(meth)acrylates, α-thiolated or αω-thiolated polybutadienes, and their blends.

According to another possibility, the initiator can be a vinyl cooligomer or copolymer of the family of the acrylic, methacrylic, styrene or diene polymers which result from copolymerization between acrylic, methacrylic, styrene or diene monomers and functional monomers exhibiting a hydroxyl group, such as hydroxylated acrylic or methacrylic monomers, such as, for example, 4-hydroxybutyl acrylate, hydroxyethyl acrylate and hydroxyethyl methacrylate. This polymerization can be carried out according to a conventional radical process, a controlled radical process or an anionic process.

According to yet another possibility, the initiator can be a vinyl copolymer obtained by controlled radical polymerization in which the radical initiator and/or the control agent carry at least one hydroxyl or thiol functional group.

The oligomers and polymers used as initiators can have, for example, a number-average molecular weight ranging from 1000 to 100 000 g/mol, for example from 1000 to 20 000 g/mol, and a polydispersity index ranging from 1 to 3 and, for example, from 1 to 2.6.

The use of such oligomers or polymers makes it possible to obtain grafted, star or linear block copolymers, according to the arrangement of the hydroxyl or thiol functional group(s) on the polymeric initiator.

Preferably, the molar ratio of the cyclic monomer to the polymeric initiator ranges from 5 to 500, more preferably from 10 to 200 and better still from 40 to 100.

The process according to the invention is advantageously carried out in anhydrous medium. Furthermore, it is preferably carried out in a nonchlorinated solvent which is advantageously an aromatic solvent, such as toluene, ethylbenzene or xylene, but which can, in an alternative form, be a nonaromatic solvent, such as ketones (including methyl ethyl ketone and methyl isobutyl ketone) and ethers and polyethers which are optionally cyclic (including methyl tert-butyl ether, tetrahydrofuran, dioxane and dimethoxyethane). Tolene is preferred for use in the present invention. This is because it has been demonstrated that this type of solvent makes it possible in particular to accelerate the polymerization.

In addition, the reactants used in this process are preferably dried before they are employed, in particular by treatment under vacuum, distillation or drying with an inert drying agent.

The process according to the invention requires the use of a catalyst which comprises, or is preferably composed of, a compound carrying a sulfonic acid functional group. The expression “sulfonic acid functional group” is understood to mean a free acid functional group and not a salt. The compound is preferably a compound of formula R—SO₃H where R denotes:
a linear alkyl group including from 1 to 20 carbon atoms or a branched or cyclic alkyl group including from 3 to 20 carbon atoms which are optionally substituted by one or more substituents chosen independently from oxo and halo groups, such as, for example, fluorine, chlorine, bromine or iodine, or
an aryl group optionally substituted by at least:
   one linear alkyl substituent including from 1 to 20 carbon atoms or one branched or cyclic alkyl group including from 3 to 20 carbon atoms, said alkyl substituent being itself optionally substituted by at least one halogen group chosen from fluorine, chlorine, bromine or iodine or by a nitro group, or
one halogen group chosen from fluorine, chlorine, bromine or iodine, or
one nitro group.

(Trifluoro)methanesulfonic acid and para-toluenesulfonic acid are preferred for use in the present invention.

The process is preferably a homogeneous catalysis process, in the sense that the catalyst is present usually in the same phase as the reactants (cyclic monomer and initiator) and not in a supported form. It is possible to vary the amount of catalyst employed in the process in order to adjust the reaction time without affecting the control of the polymerization. Usually, however, it is preferable for the molar ratio of the compound carrying the sulfonic acid functional group to each hydroxl or thiol functional group of the initiator to be between 0.5 and 1. The catalyst can be easily removed at the end of the reaction by neutralization using a hindered organic base, such as diisopropylethylamine (DIEA), followed by removal of the ammonium salts thus formed, preferably by washing with water.

It is preferable for the process according to the invention not to employ a metal entity.

This process is preferably carried out at a temperature ranging from 20° C. to 105° C., more preferably from 25° C. to 65° C. and better still from 25° C. to 50° C. This is because it has been demonstrated that it is possible to obtain, at these temperatures, for example at approximately 30° C., copolymers having molecular weights Mₙ of greater than 14 000 g/mol in only 3 to 4 hours and with a yield of at least 90%, indeed even of close to 99%, without it being necessary to operate under pressure. This is a considerable advantage of the process according to the invention.

This process is in addition preferably carried out with stirring. It can be carried out continuously or batchwise.

The copolymers prepared according to the present invention exhibit a number-average molecular weight, denoted by Mₙ and measured by gel permeation chromatography (or GPC), which is controlled by the molar ratio of the monomer to the initiator and which can be greater than 9000 g/mol and/or a polydispersity index, reflecting the good homogeneity of the chain lengths of the polymer, of less than 1.5.

It can be used in a variety of applications and in particular as membranes for the treatment of liquid or gaseous effluents or in electrochemical energy storage systems, such as lithium ion batteries, supercapacitors or fuel cells; as biocompatible materials which can be used in particular in the pharmaceutical or cosmetic field, in particular for the manufacture of systems for carrying active principles or as suturing material; as additives in plastics and in particular as antistatic additives for polymeric resins, such as polyesters, polycarbonates, polyamides or poly(meth)acrylates, as compounds which improve the impact strength of resins, such as polycarbonates, which may or may not be transparent, polyesters, polyamides or poly(meth)acrylates, or as plasticizers for PVC; or also in the manufacture of textile fibers.

The invention thus also relates to the use of a polymer composition capable of being obtained according to the process described above as antistatic additive for polymeric resins.

It also relates to the use of this composition in the manufacture of a membrane for the treatment of liquid or gaseous effluents or in electrochemical energy storage systems; as biocompatible material in the pharmaceutical or cosmetic field; as additive which improves the impact strength of resins or as plasticizer for PVC; or in the manufacture of textile fibers.

The invention will now be illustrated by the following nonlimiting examples.

### EXAMPLES

Preparation of ε-caprolactone Copolymers

The following general procedure was used to carry out the processes described below.

The alcohols and the toluene were distilled in sodium. The ε-caprolactone was dried and distilled over calcium hydride (CaH₂). The MPEG and the PEG were dried in a dessicator under vacuum in the presence of P₂O₅. The PTMG was dried under vacuum at 80° C. The sulfonic acids were used without additional purification. The diisopropylethylamine (DIEA) was dried and distilled over calcium dihydride (CaH₂) and stored over potassium hydroxide (KOH).

The Schlenk tubes were dried with a heat gun under vacuum in order to remove any trace of moisture.

The reaction was monitored by ¹H NMR, carried out on the Bruker Avance 300 device, and GPC, carried out on a Waters 712 WISP device, regulated at 40° C., 1 ml/min, using polystyrene calibration. To do this, samples were withdrawn, neutralized with DIEA, evaporated and taken up in an appropriate solvent for the purpose of the characterization thereof. ¹H NMR makes it possible to quantify the degrees of polymerization (DP) of the monomers by determining the ratio of the integration of the signals of the —CH₂— groups carrying the C═O functional group to the signals of the protons of the —CH₂— groups carrying the —OH functional group initially on the initiator. The spectra are recorded in deuterated chloroform on a 300 MHz spectrometer. GPC in THF makes it possible to determine the number-average molecular weight Mₙ and the degree of polydispersity (PDI) of the samples.

### Example 1

580 μl of ε-caprolactone (40 eq., 0.45 mol.l⁻¹) and 12 μl of trifluoromethanesulfonic acid (1 eq.) are successively added to a solution of 1.32 g (1 eq.) of PEG (Mₙ˜17 000 g/mol, PDI=1.07) in 11 ml of toluene. The reaction medium is stirred under argon at 50° C. until conversion of the monomer, established from the NMR, is completed, i.e. 4 h.

Conversion: ≧99%

¹H NMR: DP=41

GPC: Mₙ=25 350 g/mol, PDI=1.14

### Example 2

610 μl of ε-caprolactone (40 eq., 0.9 mol.l⁻¹) and 9 μl of methanesulfonic acid (1 eq.) are successively added to a solution of 0.17 g (1 eq.) of PTMG (Mₙ=2610 g/mol, PDI=2.09) in 5.5 ml of toluene. The reaction medium is stirred under argon at 30° C. until conversion of the monomer, established from the NMR, is complete, i.e. 1 h.

Conversion: ≧99%

¹H NMR: DP=40

GPC: Mₙ=10 380 g/mol, PDI=1.16

### Example 3

560 μl of ε-caprolactone (45 eq., 0.9mol.l⁻¹) and 11 μl of trifluoromethanesulfonic acid (1 eq.) are successively added to a solution of 0.265 g (1 eq.) of PMPA (dried Mₙ=3450 g/mol, PDI=2.01) in 5 ml of toluene. The reaction medium is stirred under argon at 30° C. until conversion of the monomer, established from the NMR, is complete, i.e. 1 h.

Conversion: ≧99%

¹H NMR: DP=42

GPC: Mₙ=11 260 g/mol, PDI=1.20

### Example 4

550 μl of ε-caprolactone (40 eq., 0.9 mol.l⁻¹) and 11 μl of trifluoromethanesulfonic acid (1 eq.) are successively added to a solution of 0.135 g (1 eq.) of PBA (dried Mₙ=2160 g/mol, PDI=1.90) in 5 ml of toluene. The reaction medium is stirred under argon at 30° C. until conversion of the monomer, established from the NMR, is complete, i.e. 1 h 05.

Conversion: ≧99%

NMR: DP=39

GPC: Mₙ=9660 g/mol, PDI=1.16

### Example 5

440 μl of ε-caprolactone (40 eq., 0.45 mol.l⁻¹) and 9 μl of trifluoromethanesulfonic acid (1 eq.) are successively added to a solution of 0.50 g (1 eq.) of MPEG (Mₙ˜8100 g/mol, PDI =1.05) in 8.9 ml of toluene. The reaction medium is stirred under argon at 50° C. until conversion of the monomer, established from the NMR, is complete, i.e. 3 h.

Conversion: ≧98%

¹H NMR: DP=40

GPC: Mₙ=15 080 g/mol, PDI=1.15

### Example 6

500 μl of ε-caprolactone (80 eq., 0.9 mol.l⁻¹) and 4 μl of methanesulfonic acid (1 eq.) are successively added to a solution of 68 mg (1 eq.) of polybutadiene Poly bd® R20 LM (α-, ω-hydroxylated polybutadiene of low molecular weight from Sartomer) (M˜1200 g/mol, Mₙ˜2300 g/mol, PDI=2.54) in 4.5 ml of toluene. The reaction medium is stirred under argon at 30° C. for 4 h (conversion: 100%). The medium is neutralized and evaporated.

Characterization of the product obtained by ¹H NMR: DP=65

GPC: Mₙ=14 850 g/mol, PDI=1.40

### Example 7

520 μl of ε-caprolactone (80 eq., 0.9 mol.l⁻¹) and 4 μl of methanesulfonic acid (1 eq.) are successively added to a solution of 164 mg (1 eq.) of Poly Bd® R45 (α-,ω-hydroxylated polybutadiene of low molecular weight from Sartomer) (M˜2800 g/mol, Mₙ˜5400 g/mol, PDI=2.45) in 4.7 ml of toluene. The reaction medium is stirred under argon at 30° C. for 4 h (conversion: 100%). the medium is neutralized and evaporated.

NMR: DP=53

GPC: Mₙ=19 800 g/mol, PDI=1.36

These examples show that it is possible to obtain, in approximately one hour only, copolymers having molecular weights of less than 12 000 g/mol and, in at most four hours, copolymers having molecular weights of greater than 14 000 g/mol, indeed even than 20 000 g/mol, with a polydispersity index which remains less than or equal to 1.4.

1. A process for the preparation of a copolymer of at least one cyclic monomer chosen from a lactone, a lactam, a lactide and a glycolide, comprising reacting said cyclic monomer with a polymeric initiator in the presence of a compound carrying a sulfonic acid functional group.

2. The process as claimed in claim 1, wherein the lactone is selected from the group consisting of ε-caprolactone, δ-valerolactone, β-butyrolactone and γ-butyrolactone.

3. The process as claimed in claim 2, wherein the lactone is ε-caprolactone.

4. The process as claimed in claim 1, wherein the lactam is selected from the group consisting of caprolactam, enantholactam, laurinlactam, pyrrolidinone and piperidone.

5. The process as claimed in claim 1, wherein the cyclic monomer is chosen from lactide, and glycolide.

6. The process as claimed in claim 1, wherein the polymeric initiator is a polymer comprising at least one hydroxyl functional group.

7. The process as claimed in claim 6, wherein the polymeric initiator is a mono- or polyhydroxylated oligomer or polymer selected from the group consisting of (alkoxy)polyalkylene glycols; poly(alkyl)alkylene adipate diols; α-hydroxylated or α,ω-dihydroxylated polydienes which are optionally hydrogenated; mono- or polyhydroxylated polyalkylenes; polylactides comprising end hydroxyl functional groups; polyhydroxyalkanoates; modified or unmodified polysaccharides; and their blends.

8. The process as claimed in claim 7, wherein the polymer comprising at least one hydroxyl functional group is selected from the group consisting of (methoxy)polyethylene glycol, polypropylene glycol, polytetramethylene glycol, poly(2-methyl-1,3-propylene adipate) diol, poly(1,4-butylene adipate) diol, α,ω-dihydroxylated polybutadiene, α,ω-dihydroxylated polyisoprene, mono- or polyhydroxylated polyisobutylene, poly(3-hydroxybutyrate), poly(3-hydroxyvalerate), starch, chitin, chitosan, dextran, cellulose and their blends.

9. The process as claimed in claim 1, wherein the polymeric initiator is a polymer comprising at least one thiol functional group.

10. The process as claimed in claim 9, wherein the polymeric initiator is selected from the group consisting of α-thiolated or α,ω-thiolated polystyrenes, α-thiolated or α,ω-thiolated poly(meth)acrylates, α-thiolated or α,ω-thiolated polybutadienes, and their blends.

11. The method as claimed in claim 1, wherein the polymeric initiator is a vinyl cooligomer or copolymer which results from copolymerization between acrylic, methacrylic, styrene or diene monomers and functional monomers exhibiting either a hydroxyl group or a thiol group.

12. The process as claimed in claim 1, wherein the compound carrying a sulfonic acid functional group is a compound of formula R—SO₃H where R denotes:
a linear alkyl group including from 1 to 20 carbon atoms or a branched or cyclic alkyl group including from 3 to 20 carbon atoms, which said alkyl groups are optionally substituted by one or more substituents chosen independently from oxo and halo groups, or
an aryl group optionally substituted by at least:
one linear alkyl substituent including from 1 to 20 carbon atoms or one branched or cyclic alkyl group including from 3 to 20 carbon atoms, said alkyl substituent or group being itself optionally substituted by at least one halogen group chosen from fluorine, chlorine, bromine or iodine,, or by a nitro group, or
one halogen group chosen from fluorine, chlorine, bromine or iodine, or
one nitro group.

13. The process as claimed in claim 12, wherein the compound carrying a sulfonic acid functional group is (trifluoro)methanesulfonic acid or para-toluenesulfonic acid.

14. The process as claimed in claim 1, wherein the molar ratio of the cyclic monomer to the polymeric initiator ranges from 5 to 500.

15. The process as claimed in claim 1, wherein the process is carried out in a nonchlorinated solvent.

16. The process as claimed in claim 15, wherein the process is carried out in a nonchlorinated aromatic solvent.

17. The process as claimed in claim 1, wherein the process is carried out in an anhydrous medium.

18. The process as claimed in claim 1, wherein the molar ratio of the compound carrying a sulfonic acid functional group to each hydroxyl or thiol functional group of the polymeric initiator is 1.

19. The process as claimed in claim 1, wherein the process is carried out at a temperature ranging from 20° C. to 105° C.

20. A polymer composition capable of being obtained according to the process as claimed in claim 1.

21. The use of the composition as claimed in claim 20 as antistatic additive for polymeric resins.

22. The use of the composition as claimed in claim 20 in the manufacture of a membrane for the treatment of liquid or gaseous effluents or in electrochemical energy storage systems; as a biocompatible material in the pharmaceutical or cosmetic field; as an additive which improves the impact strength of resins or as plasticizer for PVC; or in the manufacture of textile fibers
